(19) United States
(12) Patent Application Publication
(10) Pub. No.: US 2011/0298891 A1
(43) Pub. Date: Dec. 8, 2011

(54) COMPOSITE PHASE-SHIFTING ALGORITHM FOR 3-D SHAPE COMPRESSION

(75) Inventors: Song Zhang, Ames, IA (US); Nikolaus Karpinsky, Ames, IA (US)

(73) Assignee: IOWA STATE UNIVERSITY RESEARCH FOUNDATION, INC., Ames, IA (US)

(21) Appl. No.: 13/116,540

(22) Filed: May 26, 2011

Related U.S. Application Data
(60) Provisional application No. 61/351,565, filed on Jun. 4, 2010.

(51) Int. Cl. H04N 13/04; H04N 13/00

(52) U.S. Cl. 348/43; 348/51; 348/E13.026; 348/E13.062

(57) ABSTRACT

A method includes acquiring a 3-D geometry through use of a virtual fringe projection system and storing a representation of the 3-D geometry as a RGB color image on a computer readable storage medium A method for storing a representation of a 3-D image includes storing on a computer readable storage medium a 24-bit color image having a red channel, a green channel, and a blue channel. The red channel includes a representation of a sine fringe image. The green channel includes a representation of a cosine fringe image. The blue channel includes a representation of a stair image or other information for use in phase unwrapping. Alternatively, all channels may include representations of fringe patterns.

### CROSS-REFERENCE TO RELATED APPLICATIONS

This application claims priority under 35 U.S.C. §119 to provisional application Ser. No. 61/351,565 filed Jun. 4, 2010, herein incorporated by reference in its entirety.

### FIELD OF THE INVENTION

The present invention relates to 3-D data. More specifically, but not exclusively, the present invention relates to compression of 3-D shape data.

### BACKGROUND OF THE INVENTION

With recent advancements in 3-D imaging and computational technologies, acquiring 3-D data is unprecedentedly simple. During the past few years, advancements in digital display technology and computers have accelerated research in 3-D imaging techniques. Yet despite these advancements, problems remain.

For example, 3-D geometries have larger sizes than 2-D images. Thus, when working in real-time 3-D imaging there are significantly higher data throughput requirements which makes it difficult to store and transmit information. What is needed are ways to store and transmit 3-D data especially in real-time. What is also needed are ways to compress the 3-D data for storage and transmission.

### BRIEF SUMMARY OF THE INVENTION

Therefore, it is a primary object, feature, or advantage of the present invention to improve over the state of the art.

It is a further object, feature, or advantage of the present invention to encode a 3-D surface into a single 2-D color image.

Yet another object, feature, or advantage of the present invention is to recover a 3-D shape from a 2-D color image.

A still further object, feature, and advantage of the present invention is to provide for storing representation of 3-D surfaces in 2-D file formats.

A further object, feature, or advantage of the present invention is to allow for high compression ratios for storage of representations of 3-D data.

A still further object, feature, or advantage of the present invention is to allow for conventional image compression methods to be used to compress 3-D geometries.

Another object, feature, or advantage of the present invention is to provide for handling of 3-D data in a way that may be used in any number of different applications including 3-D video conferencing or 3-D video calling.

One or more of these and/or other objects, features, and advantages will become apparent from the specification and/or claims. No single embodiment of the present invention need exhibit all objects, features, or advantages.

According to one aspect of the present invention, a method includes acquiring a 3-D geometry through use of a virtual fringe projection system and storing a representation of the 3-D geometry as a RGB color image on a computer readable storage medium.

According to another aspect of the present invention, a method for storing a representation of a 3-D image includes storing on a computer readable storage medium a 24-bit color image having a red channel, a green channel, and a blue channel. A first of the channels includes a representation of a sine fringe image. A second of the channels includes a representation of a cosine fringe image. A third of the channels includes a representation of a stair image or other information for use in phase unwrapping.

According to another aspect of the present invention, a computer readable storage medium has stored thereon one or more sequences of instructions to cause a computing device to perform steps for generating a 24-bit color image, the steps including storing a representation of a 3-D geometry acquired through use of a virtual fringe projection system as a 24-bit color image.

According to another aspect of the present invention, a method includes receiving a representation of a 3-D geometry as a color image having a sine image on a first channel, a cosine image on a second channel, and phase unwrapping information on a third channel. The method further provides for processing the color image on a computing device to use the sine image, the cosine image, and the phase unwrapping information to construct a representation of the 3-D geometry.

### BRIEF DESCRIPTION OF THE DRAWINGS

FIG. 1 is a diagram of virtual digital fringe projection system setup. The virtual projection system projects sinusoidal fringe patterns onto the object and rendered by the graphics pipeline, and then displayed on the screen. The screen view acts as a virtual camera imaging system. Because both the projector and the camera are virtually constructed, they could be both orthogonal devices.

FIG. 2 is a schematic diagram of the proposed composite algorithm for single color fringe image generation. (a) Cross section of the color fringe images, red is the sine image (Iᵣ), green is the cosine image (I_{g}) and blue is the stair image (I_{b}); (b) The cross section of the phase map (θ(x, y)) using red and green fringe images from Eq. 3; (c) The real fringe image; (d) The unwrapped phase after correcting the wrapped phase (θ(x, y)) by the stair image (I_{b}).

FIG. 3 is a schematic diagram for phase to coordinate conversion.

FIG. 4 illustrates 3-D recovery using the single color fringe image. (a) Fringe image; (b) Phase map using red and green channels of the color fringe image; (c) Stair images (blue channel); (d) Unwrapped absolute phase map; (e) 3-D shape before applying median filtering; (f) 3-D shape after applying median filtering.

FIG. 5 is a comparison between the reconstructed 3-D shape and the theoretical one. (a) Cross section of 256^{th} row; (b) Difference (RMS: 1.68×10⁻⁴ mm or 0.03%).

FIG. 6 illustrates 3-D recovery for step height object. (a) Color fringe image; (b) Unwrapped phase map; (c) 3-D shape.

FIG. 7 illustrates 256^{th} row of the step height object.

FIG. 8 illustrates 3-D recovery using the color fringe image for scanned data. (a) 3-D scanned original data; (b) Color fringe image; (c) Unwrapped phase map; (d) 3-D reconstructed shape; (e) Overlap original 3-D shape (yellow) and the recovered 3-D shape (gray) in shaded mode; (f) Overlap original 3-D shape (blue) and the recovered 3-D shape (red) in shaded mode.

FIG. 9 illustrates 3-D reconstruction under different compression ratio. (a) PNG format (1:19.90); (b) JPG+PNG format (1:36.86); (c) JPG+PNG format (1:36.96); (d) JPG+PNG format (1:41.71).

FIG. 10 is a block diagram of showing two devices capable of acquiring and displaying 3-D imagery and communicating the 3-D imagery bi-directionally.

FIG. 11 illustrates the encoded structured pattern. (a) The structured pattern, whose three channels are all encoded with cosine functions. (b) One cross section of the structured pattern. Note that all channels use cosine waves to reduce problems associated with lossy encoding.

FIG. 12. Example of the Holovideo codec encoding a single frame from 3D to 2D and then decoding back to 3D. (a) The original scanned 3D geometry by a structured light scanner; (b) The encoded 3D frame into 2D image; (c)-(e) Three color channels of the encoded 2D image frame; (f) Wrapped phase from red and green channel fringe patterns; (g) Image codec used for unwrapping the wrapped phase point by point; (h) The unwrapped phase map using Eq. (8); (i) The unwrapped phase after filtering; (j) The normal map; (k) The final 3D recovered geometry; (1) Overlapping the original 3D geometry with the recovered one.

FIG. 13. The effect of compressing an individual frame with a lossy JPEG file format. (a)-(d) The Holovideo encoded compressed frame with different compression ratios; (e)-(h) The corresponding decoded 3D geometry from the above images. (i)-(l) The 3D geometry of above row after boundary cleaning. The images in (a)-(d) respectively show the compression ratios of 104:1, 174:1, 237:1, and 310:1 when compared against the OBJ file format.

FIG. 14. Comparing results of storing prior encoded image with a lossy JPEG file format. (a) The encoded Holovideo frame using the method previously discussed; (b) Overlap the original 3D scanned data with the recovered 3D geometry from the lossless bitmap file; (c) 3D recovered shape when the image was stored as lossy JPEG format with quality level 12; (d) 3D recovered shape when the image was stored as lossy JPEG format with quality level 10.

FIG. 15. 3D video compression result using the proposed Holovideo technique (Media 1). The left video shows the original scanned 3D video, the middle video shows the encoded Holovideo, and the right video shows the decoded 3D video.

### DETAILED DESCRIPTION OF THE PREFERRED EMBODIMENT

### 1. Introduction

With recent advancements in 3-D imaging and computational technologies, acquiring 3-D data is unprecedentedly simple. During the past few years, advancements in digital display technology and computers have accelerated research in 3-D imaging techniques. The 3-D imaging technology has been increasingly used in both scientific studies and industrial practices. Real-time 3-D imaging recently emerged, and a number of techniques have been developed [1-5]. For example, we have developed a system to measure absolute 3-D shapes at 60 frames/sec with an image resolution of 640×480 [6]. The 3-D data throughput of this system is approximately 228 MB/sec, which is very difficult to store and transmit simultaneously. What is needed is a method to store and transmit the 3-D data in real time is vital.

Unlike 2-D images, 3-D geometry conveys much more information, albeit at the price of increased data size. In general, for a 2-D color image, 24 bits (or 3 bytes) are enough to represent each color pixel (red (R), green (G), and blue (B)). However, for 3-D geometry, an (x, y, z) coordinate typically needs at least 12 bytes excluding the connectivity information. Thus, the size of 3-D geometry is at least 4 times larger than that of a 2-D image with the same number of points.

There are numerous ways to represent 3-D data. Wikipedia lists most of the commonly used file formats (http://en.wikipedia.org/wiki/List_of_file_formats). 3-D data are usually represented in different ways for different purposes. In computer-aided design (CAD). STL is one of the commonly used file formats. It describes a raw unstructured triangulated surface by the unit normal and vertices. This file format does not include texture information. Because STL is a file format native to the stereo lithography computer aided design (CAD) software created by 3-D systems, it is widely used for rapid prototyping and computer-aided manufacturing (http://en.wikipedia.org/wiki/STL_(file_format)). In computer graphics, OBJ file format is one of the most commonly accepted formats. It is a simple data-format that represents geometry alone. The position of each vertex, the uv coordinate of each texture coordinate vertex, normals, and the faces that make each polygon defined as a list of vertices, and texture vertices (http://en.wikipedia.org/wiki/Obj). Because these data formats require store connectivity information, 3-D file size is relatively large. Mat5 is a native format that stores the natural data captured by an area 3-D scanner, it stores five matrices: the color, the quality, the x, the y, and the z (http://www.engr.uky.edu/˜lgh/soft/softmat5format.htm). This is essentially an unstructured data, thus the connectivity information is naturally stored (captured), by splitting grids into triangles. This file format is thus smaller in comparison with other data formats.

Another benefit of the Holoimage format is that it can use existing research of 2-D image processing. 2-D image processing is well studied field, and the size of 2-D images is much smaller than that of 3-D geometries. The idea of a reduced data size and existing techniques for 3-D image process is attractive. Since 3-D geometry is usually obtained by 2-D devices (e.g., a digital camera), it is natural to use its originally acquired 2-D format to compress it.

Here, we address a technique that converts 3-D surfaces into a single 2-D color image. The color image is generated using advanced computer graphics tools to synthesize a digital fringe projection and phase-shifting system for 3-D shape measurement. We propose a new coding method named “composite phase-shifting algorithm” for 3-D shape recovery. With this method, two color channels (R, G) are encoded as sine and cosine fringe images, and the third color channel (B) is encoded as a stair image; the stair image can be used to unwrap the phase map obtained from two fringe images point by point. By using a 24-bit image and no spatial phase unwrapping, the 3-D shape can be recovered; therefore the single 2-D image can represent a 3-D surface.

The encoded 24-bit images can be stored in different formats, e.g., bitmap, portable network graphics (PNG), and JPG. If the image is stored in a lossless format, such as bitmap and PNG, the quality of 3-D shape is not affected at all. We found that lossy compression such as JPG compression cannot be directly implemented, as it distorts the blue channel severally affecting the 3-D surface. To circumvent this problem, red and green channels are stored using JPG under different compression levels while the blue channel remains in a lossless PNG format. Our experiments demonstrated that there is little error for a compression ratio up to 1:36.86 comparing with the native smallest possible 3-D data representation method. Experiments will be presented to verify the performance of the proposed approach.

Section 2 presents the fundamentals of the virtual fringe projection system and the composite phase-shifting algorithm. Section 3 shows experimental results. Section 4 discusses various examples of applications, and finally Section 4 summarizes.

### Principle

### 2.1 Virtual Digital Fringe Projection System Setup

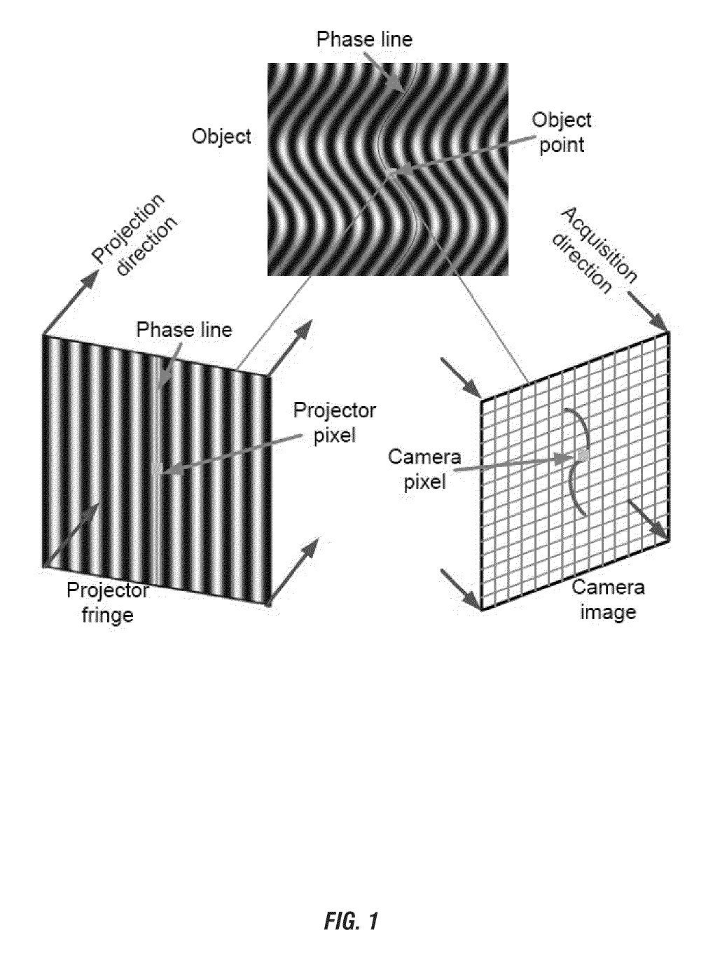

FIG. 1 shows a virtual fringe projection system setup, which is also known as a Holoimage system [7]. It is very similar to that a real fringe projection based 3-D shape measurement system. A projector projects fringe images onto an object and a camera captures the fringe images that the object has distorted. 3-D information can be retrieved if the geometric relationship between the projector pixels and the camera pixels are known.

The virtual system differs from the real 3-D shape measurement system in that the projector and the camera are orthogonal devices instead of perspective ones, and the relationship between the projector and the camera are precisely defined. Thus, the shape reconstruction becomes significantly simplified and precise. To represent an arbitrary 3-D shape, a multiple-wavelength phase-shifting algorithm [8-11] can be used. However, it requires more than three fringe images to represent one 3-D shape, which is not desirable for data compression.

### 2.2 Composite Phase-Shifting Algorithm

Due to the virtual nature of the system, all environmental variables can be precisely controlled, simplifying the phase-shifting process. To obtain phase, only sine and cosine images are actually needed, which can be encoded into two color channels, e.g., red, green channels.

The intensity of these two images can be written as,

Iᵣ(x,y)=255/2[1+sin(φ(x,y))]. (1)

I_{g}(x,y)=255/2[1+cos(φ(x,y))]. (2)

From the previous two equations, we can obtain the phase

$$φ ( x , y ) = {tan}^{- 1} [ \frac{{I}_{r} - 255 / 2}{{I}_{g} - 255 / 2} ] . \qquad ( 3 )$$

The phase obtained in Eq. (3) ranges [−π,+π). To obtain a continuous phase map, a conventional spatial phase unwrapping algorithm can be used. However, it is known that the step height changes between two pixels cannot be larger than π. The phase unwrapping step is essentially to find the integer number (K) 2π jumps for each pixel so that the true phase can be found [12]

Φ(x,y)=2πK+φ(x,y). (4)

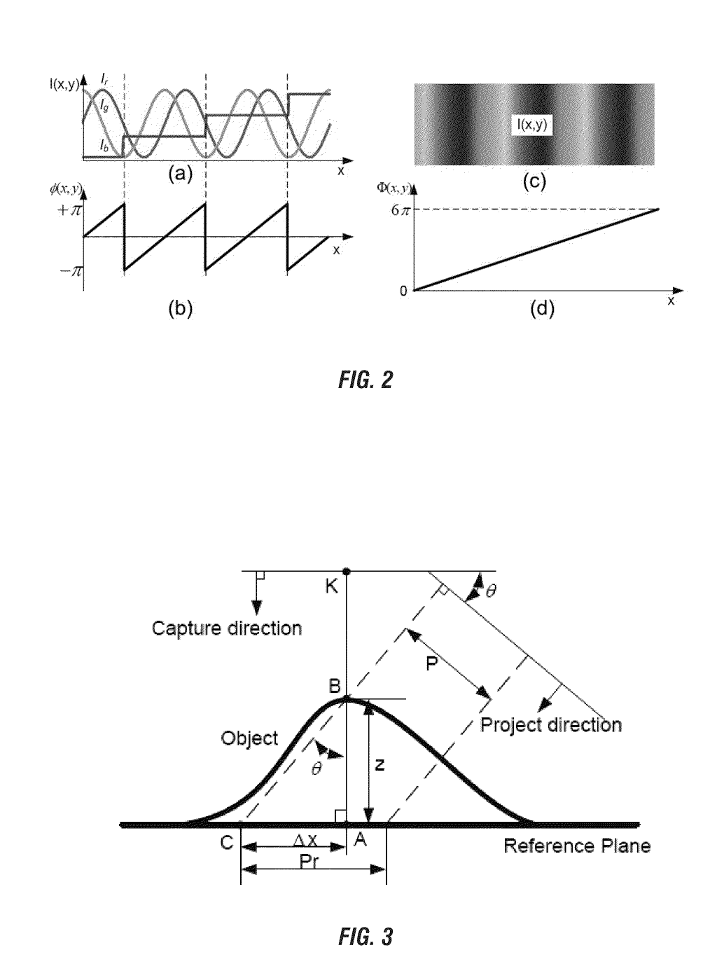

If an additional stair image, I_{b}(x, y), is used whose intensity changes are precisely aligned with the 2π phase jumps (as shown in FIG. 2), the phase unwrapping step can be performed point by point by using the stair image information. In other words, the unwrapped phase will be

Φ(x,y)=2πI_{b}(x,y)+φ(x,y). (5)

In practice, to reduce the problems caused by digital effects, instead of using one grayscale value for each increment, a larger value is used. In the example shown in FIG. 2, 80 grayscale values are used to represent one stair.

### 2.3 Phase-to-Coordinate Conversion

FIG. 3 illustrates the phase-to-coordinate conversion. To explain the concepts, a reference plane (a flat surface with z=0) is used. Assume the fringe pitch generated by the projector is P and the projection angle is θ, the fringe pitch on the reference plane will be Pᵣ=P/cos θ. For an arbitrary image point K, if there is no object in place, the phase is Φ_{A}^{r} on the reference plane. Once the object is in position, the imaging point on the object is B. From the projector point of view, B on the object and C on the reference plane have the same phase, i.e., Φ=Φ_{B}=Φ_{C}^{r}. Then, we have

ΔΦ=Φ_{C}^{r}−Φ_{A}=Φ_{B}^{r}−Φ_{A}^{r}=Φ−Φ_{A}^{r}. (6)

Since the fringe stripes are uniformly distributed on the reference plane. For the pipeline introduced herein, the reference plane is well defined (z=0). The phase on the reference plane is defined as a function of the projection angle θ and the fringe pitch P,

Φ^{r}=2πi/Pᵣ=2πi cos θ/P (7)

assuming phase 0 is defined at i=0 and the fringe stripes are vertical. Here, i is the image index horizontally. From Eqs. (6) and (7), we have,

ΔΦ=Φ−2πi cos θ/P (8)

Also we have,

ΔΦ=Φ_{C}^{r}−Φ_{A}^{r}=2πΔi cos θ/P (9)

Moreover, the graphics pipeline can be configured to visualize within a unit cube, when pixel size is 1/W. Here, W is the total number of pixel horizontally, or window width. Then

x=i/W (10)

assume the origin of the coordinate system is aligned with the origin of the image.

Similarly, for they coordinate, assume y direction has the same scaling factor, we have

y=j/W (11)

here j is the image index vertically.

From the geometric relation of the diagram in FIG. 3, it is obvious that

z=Δx/tan θ (12)

Combining this equation with Esq. (9) and (10), we will have

$$z = \frac{P Δ Φ}{2 π W sin θ} \qquad ( 13 )$$

Finally, the equation governing the z coordinate calculation is

$$z = \frac{P ( Φ - 2 π i cos θ / P )}{2 π W sin θ} \qquad ( 14 )$$

which is a function of the projection angle θ, the fringe pitch P, and the phase P obtained from the fringe images.

### 2.4 Composite Method for 3-D Shape Recovery

For the previously introduced algorithm, because a stair image is used for the blue channel, any information loss will induce a problem in correctly recovering 3-D geometry, thus the whole color image cannot be stored in any lossy format. Therefore, its value is significantly reduced. To reduce the problem caused by the stair image, we introduced a new algorithm. The red and green channel remain the same, while the blue channel is replaced with a new structure that can be formulated as:

I_{b}=S×Floor(x/P)−(S−2)/2×cos [2π×Mod(x,P)/P₁], (15)

assuming the fringe stripes are vertical. Here, P is the fringe pitch, the number of pixels per fringe strip for red and blue channels, P₁=P/(K+0.5) is the local fringe pitch and K is an integer number, S is the stair height in grayscale intensity value, Mod(a,b) is to get the remaining of a/b, and Floor(x) is the get the integer number of x by removing its decimals. The phase can be unwrapped using the following equation:

Φ(x,y)=2π×Floor[I_{b}(x,y)/S]+φ(x,y) (16)

Because three channels of the color image are all varying smoothly, a lossy compression will not result in the same issues as if sharp edges were present.

### 3. Experiment

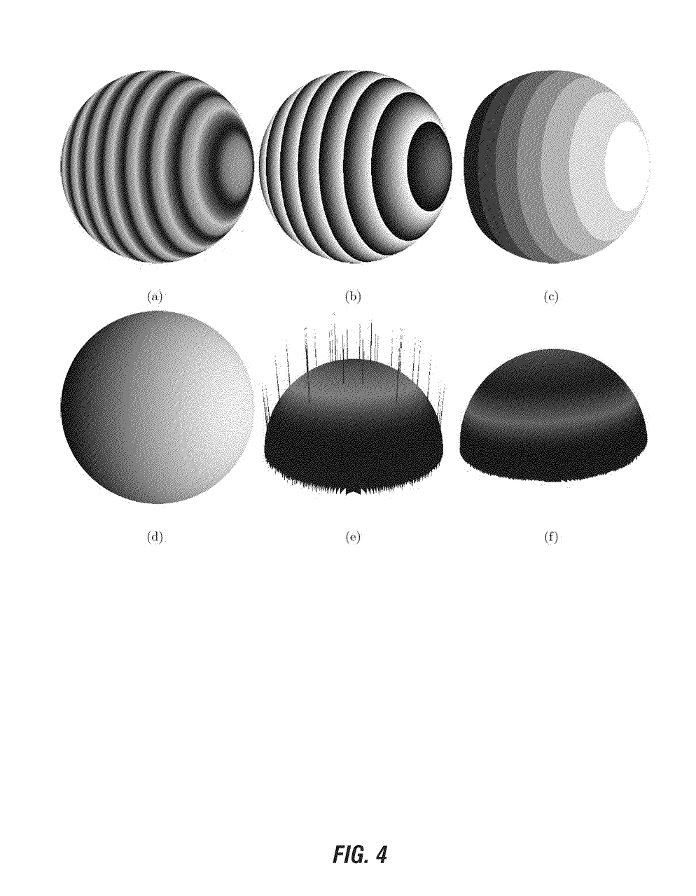

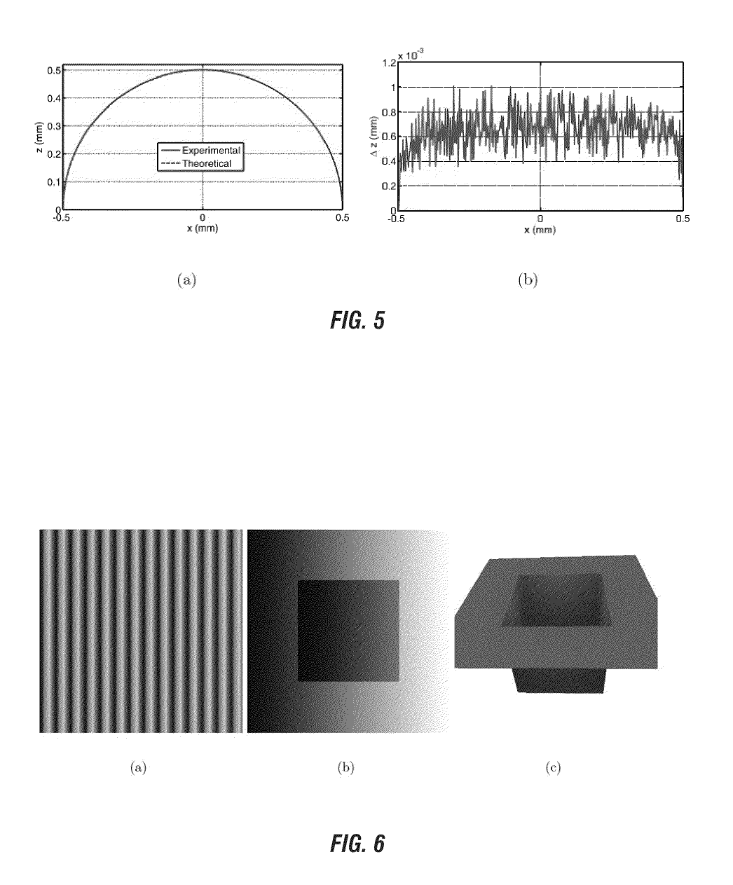

To verify the performance of the proposed approach, we first tested a sphere with a diameter of 1 mm (unit can be any since it is normalized into a unit cube) as shown in FIG. 5, whose color fringe image is shown as FIG. 4(a). In this example, we used a stair step height of 5, projection angle of θ=30°, and a fringe pitch of P=16 pixels. All of the fringe images used herein, have exactly the same setup. From the red and green channels, the phase map can be calculated by Eq. (3), which is shown in FIG. 4(b). The blue channel (shown in FIG. 4(c)) is then applied to unwrap the phase map point by point using Eq. (5), the result is shown in FIG. 4(d). On this unwrapped phase map, there are some artifacts (white dots) that are not clearly shown in this figure (will be more clearly shown in FIG. 4(e)). Using the phase-to-coordinate conversion algorithm introduced in Subsection 2.3, the phase map can be converted to 3-D, which is shown in FIG. 4(e). The artifacts (spikes) are more obvious. It is caused by the sampling of the projector and the camera. Because the projector and the camera are digital devices, the discrete signal of the fringe images and the stair image introduce a subpixel shift between the jumps. Fortunately, because this shift is limited to 1 pixel either left or right, this problem can be fixed using a conventional image processing technique, e.g., median filtering in phase domain. FIG. 4(f) shows the corrected result.

The cross section of the reconstructed 3-D shape and the theoretical sphere is shown in FIG. 5(a), and the difference is shown in FIG. 5(b). It is very obvious that the difference is negligible.

Because this algorithm allows point by point phase unwrapping, it can be used to reconstruct arbitrary shapes of an object with an arbitrary number of steps. To verify this, we tested a step-height surface: a flat object with a deep squared hole. The color image is shown in FIG. 6(a), even though the object has height variations greater than the step height, the fringe image does not appear to have discontinuities; this is because the virtual system is different from real 3-D shape measurement system in that the light can pass through objects.

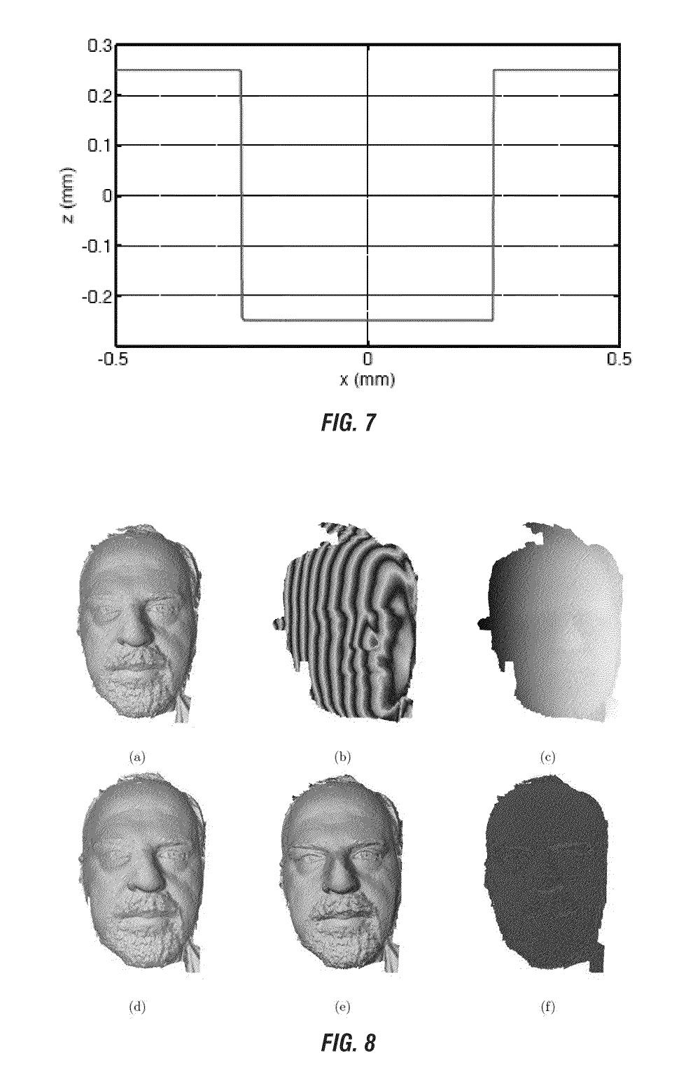

The phase map obtained from the fringe images is shown in FIG. 6(b), the phase jumps are very obvious. Because this technique uses the third channel to unwrap the phase, the 3-D shape can be correctly reconstructed, which is shown in FIG. 6(c). This 3-D shape has large height variations, greater than one period of phase range, yet is correctly reconstructed. FIG. 7 shows the cross section of the 3-D shape.

An actual scanned 3-D object is then tested for the proposed algorithm. FIG. 8 shows the experimental result. The original shape is shown in FIG. 8(a), the color fringe image is shown in FIG. 8(b), the unwrapped phase map and the recovered 3-D shape are shown in FIG. 8(c) and FIG. 8(d), respectively. If the original shape and the recovered shape are rendered in the same window, the results are shown in FIG. 8(e) in shaded mode and FIG. 8(f) in wireframe mode. It clearly demonstrates that the recovered 3-D shape and the original shape are almost perfectly aligned, that is, the recovered 3-D shape and the original 3-D shape do not have significant difference.

All these experiments demonstrate that the proposed single image technique can be used to represent an arbitrary 3-D surface shape, thus can be used for shape compression. We performed further experiments that use different image formats and compare the 3-D reconstruction quality. Here, we tested Bitmap, PNG, and differing compression levels of JPG. A typical 3-D surface shown in FIG. 8(a) is used to verify the performance. In a natively binary format (xyzm), a 512×512 3-D surface together, storing x, y, z coordinates and the mask information will be at least 3,407,872 bytes (4 bytes floating point for each coordinate, and 1 byte for mask). Most popular 3-D formats, such as OBJ, STL, use much more space. The bitmap color image has a size of 786,486 bytes, which is approximately 4.33 times smaller. In this experiment, we use the bitmap color image as it is uncompressed lossless.

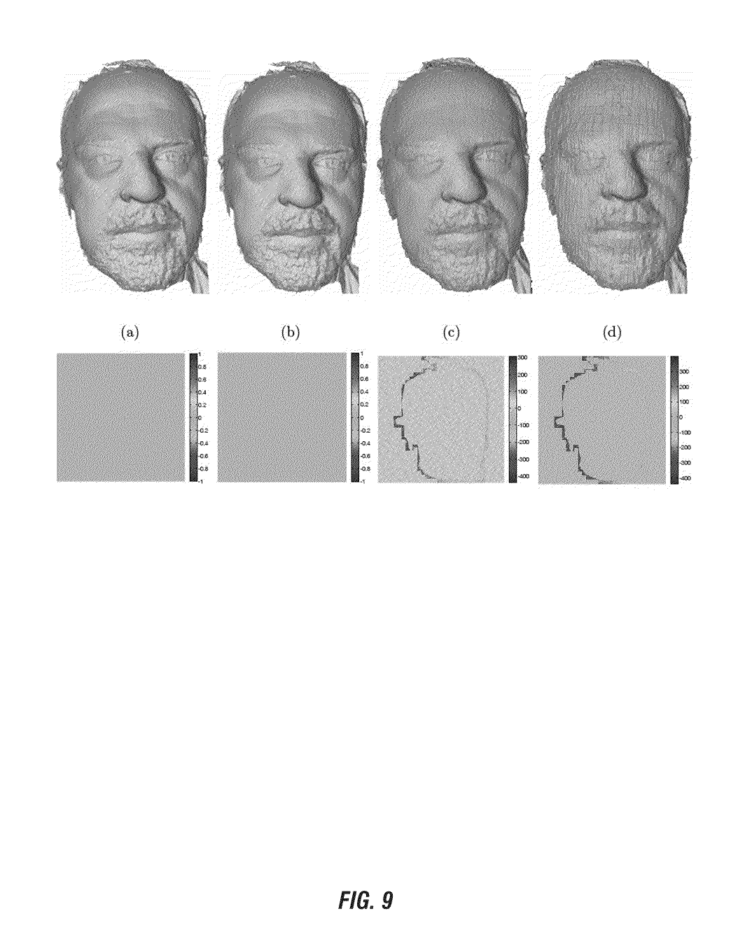

FIG. 9 shows the results. Portable network graphics (PNG) image format was first used to compress the image data. Since the PNG format is lossless, the original 3-D data can be recovered without any loss, while the file size is reduced to 171,257 bytes (compression ratio of 1:19.90). FIG. 9(a) shows the reconstructed 3-D shape and FIG. 9(e) shows the difference between the reconstructed 3-D shape and the original 3-D shape. It can be seen that there is no difference at all. We found that the color image cannot be directly compressed into JPG format because the third channel (blue) is intolerant of noise. To circumvent this problem, we compress red and green channels using a JPG format while retaining the blue channel in PNG format. In this manner, the file size is reduced to 92,446 bytes while retaining the 3-D shape quality with a compression ratio 1:36.86. FIG. 9(b) and FIG. 9(f) shows the reconstructed 3-D shape and the difference map, respectively. When we further compress red and green channels to a size of 92,192 byte, the image quality slightly drops, as shown in FIG. 9(c) and FIG. 9(g). It is interesting to notice that the boundary dropped more than the inside of the shape, because the boundary has sharp edges. We also demonstrated that when the file size is further reduced to 81,713 bytes, the 3-D shape quality is reduced substantially. The results are show in FIG. 9(d) and FIG. 9(h). This experiment shows that the color image can be substantially compressed without losing the data quality.

In addition, we compared the file size with some other commonly used 3-D data formats. Table 1 gives a comparison of various 3-D shape formats. In general, the 3-D data format requires connectivity information (e.g., OBJ, STL), the compression ratio is over 139. Comparing the formats, the native binary format (xyzm) gives the best compression as it was designed specifically to store point cloud data from 3-D scanners disregarding polygon links; even this format is over 36 times larger than a compressed Holoimage.

TABLE 1
Table 1: Compression comparison of various 3-D formats compared to the Holoimage format.

| | Compressed | PNG | XYZM | MATS | PLY | DAE | OBJ | STL |
|---|---|---|---|---|---|---|---|---|
| File Size | 92 KB | 210 KB | 3.4 MB | 5.5 MB | 6.5 MB | 10.6 MB | 12.8 MB | 17.0 MB |
| Ratio: | 1:1 | 1:2.28 | 1:36.86 | 1:59.78 | 1:70.65 | 1:115.22 | 1:139.13 | 1:184.78 |

Formats contain only vertices and connectivity if required, and are in binary format if applicable to the format; no point normals or texture coordinates are stored.

### 4. Variation with all Three Channels Using Smooth Cosine Functions and Lossy Image Format

In the above-described technique an arbitrary 3D shape can be encoded as a 24-bit color image with red and green channel as sine and cosine fringe images, with the blue channel as the stair image for phase unwrapping. Because the third channel is used to unwrap the phase map obtained from red and green channels of fringe images point by point, no spatial phase unwrapping is necessary, thus it can be used to recover arbitrary 3D shapes. However, because a stair image is used for the blue channel, any information loss will induce problems to correctly recover 3D geometry, thus the whole color image cannot be stored in any lossy format. This problem becomes more significant for videos because most 2D video formats are inherently lossy.

To circumvent this problem, the blue channel may be encoded with smoothed cosine functions. Because all three channels use smooth cosine functions, lossy image format can be used to restore the original geometry. Because a lossy image format can be used, it enables 3D video encoding with standard 2D video formats. This technique is called Holovideo. The Holovideo technique allows existing 2D video codecs such as QuickTime Run Length Encoding (QTRLE) to be used on 3D videos, resulting in compression rations of over 134:1 Holovideo to OBJ format. Under a compression ratio of 134:1, Holovideo to OBJ file format, the 3D geometry quality drops at a negligible level. Several sets of 3D videos were captured using a structured light scanner, compressed using the Holovideo codec, and then uncompressed and displayed to demonstrate the effectiveness of the codec. With the use of OpenGL Shaders (GLSL), the 3D video codec can encode and decode in realtime. We demonstrate that for a video size of 512×512, the decoding speed is 28 frames per second (FPS) with a laptop computer using an embedded NVIDIA GeForce 9400m graphics processing unit (GPU). Encoding can be done with this same setup at 18 FPS, making this technology suitable for applications such as interactive 3D video games and 3D video conferencing.

### 4.1 Principle

4.1.1. Fringe Projection Technique

Fringe projection technique is a special structured light method in that it uses sinusoidally varying structured patterns. In a fringe projection system, the 3D information is recovered from phase which is encoded naturally into the sinusoidal pattern. To obtain the phase, a phaseshifting algorithm is typically used. Phase shifting is extensively used in optical metrology because of its numerous merits which include the capability to achieve pixel-by-pixel spatial resolution during 3D shape recovery. Over the years, a number of phase-shifting algorithms have been developed including three-step, four-step, least-square algorithms, etc. [13]. In a real-world 3D imaging system using a fringe projection technique, a three-step phase-shifting algorithm is typically used because of the existence of background lighting and noise. Three fringe images with equal phase shift can be described as

I₁(x,y)=I′(x,y)+I″(x,y)cos(φ−2π/3), (17)

I₂(x,y)=I′(x,y)+I″(x,y)cos(φ), (18)

I₃(x,y)=I′(x,y)+I″(x,y)cos(φ+2π/3). (19)

Where I′(x,y) is the average intensity, I″(x,y) the intensity modulation, and θ (x,y) the phase to be found. Simultaneously solving Eqs. (17)-(19) leads to

φ(x,y)=tan⁻¹└\sqrt{3}(I₁−I₃)/(2I₂−I₁−I₃)┘. (20)

This equation provides the wrapped phase ranging from 0 to 2π with 2π discontinuities. These 2π phase jumps can be removed to obtain the continuous phase map by adopting a phase-unwrapping algorithm [17]. However, all phase-unwrapping algorithms have the common limitations that they can resolve neither large step height changes that cause phase changes larger than p nor discontinuous surfaces.

4.1.2. Holovideo System Setup

The Holovideo technique is devised from the digital fringe projection technique. The idea is to create a virtual fringe projection system, scan scenes into 2D images, compress and store them, and then decompress and recover the original 3D scenes. Holovideo utilizes the basis of the Holoimage technique [7] to accomplish the task of depth-mapping an entire 3D scene. FIG. 1 shows the typical setup of the Holovideo system. The projector projects fringe images onto the object and the camera captures reflected fringe images from another viewing angle. From the camera image, 3D information can be recovered pixel by pixel if the geometric relationship between the projector pixel (P) and the camera pixel (C) is known. Because Holoimage system is precisely defined by the user, both the camera and the projector can be orthogonal devices, their geometric relationship is easy to obtain. Thus, the phase to coordinate conversion is very simple. In the virtual fringe projection system, the projector is configured as the projective texture image to project the texture onto the object, the computer screen acts as the camera. The projection angle (A), the angle between the projection system and the camera imaging system, is realized by setting the model view matrix of the OpenGL pipeline.

4.1.3. Encoding on GPU

To speed up the encoding process, the Holovideo system was constructed on GPU. The virtual fringe projection system is created through the use of GLSL Shaders which color the 3D scene with the structured light pattern. The result is rendered to a texture, saved to a video file, and uncompressed later when needed. By using a sinusoidal pattern for the structured light system, lossy compression can be achieved without major loss of quality.

As stated before, the Holovideo encoding shader colors the scene with the structured light pattern. To accomplish this, a model view matrix for the projector in the virtual structured light scanner is needed. This model view matrix is rotated around the z axis by some angle (q=18° in our case) from the camera matrix. From here the Vertex Shader can pass the x;y values to the Fragment Shader as a varying variable along with the projector model view, which can then be used to find the x;y values for each pixel from the projectors perspective. At this point, each fragment is colored with the Eqs. (21)-(23), and the resulting scene is rendered to a texture giving a Holo-encoded scene.

Iᵣ(x,y)=0.5+0.5 sin(2πx/P), (21)

I_{g}(x,y)=0.5+0.5 cos(2πx/P), (22)

I_{b}(x,y)=S·Fl(x/P)+S/2+(S−2)/2·cos [2π·Mod(x,P)/P₁], (23)

Here P is the fringe pitch, the number of pixels per fringe stripe, P₁=P/(K+0.5) is the local fringe pitch and K is an integer number, S is the stair height in grayscale intensity value, Mod(a,b) is the modulus operator to get a over b, and Fl(x) is to get the integer number of x by removing the decimals. FIG. 11 illustrates a typical structure pattern for Holovideo.

After each render, which renders to a texture, we pull the texture from the GPU and save it as a frame in the current movie file. The two main bottlenecks are transferring all of the geometry to the graphics card to be encoded, and copying the resulting texture from the graphics card to the movie file in the computer memory. Since we already have to transfer the geometry to the GPU there is nothing we can do about the former bottleneck. The latter bottleneck, however, can be mitigated by accessing textures from the GPU through DMA using pixel buffer objects, resulting in asynchronous transfers.

4.1.4. Decoding on GPU

Decoding the resulting Holovideo is more involved than encoding, as there are more steps, but it can be scaled to the hardware by simply subsampling. In decoding, four major steps need to be accomplished: (1) calculating the phase map from the Holovideo frame, (2) filtering the phase map, (3) calculating normals from the phase map, and (4) performing the final render. To accomplish these four steps, we utilized multipass rendering, saving results from the intermediate steps to a texture, which allowed us to access neighboring pixel values in proceeding steps.

To calculate the phase map, we set up the rendering with an orthographic projection and a render texture and then rendered a screen-aligned quad. With this setup, we can perform image processing using GLSL. From here, the phase-calculating shader took each pixel value and applied Eq. (24) below, saving the result to a floating-point texture for the next step in the pipeline. Equations (21)-(23) provide the phase uniquely for each point.

Φ(x,y)=2π×Fl[(I_{b}−S/2)/S]+tan⁻¹[(Iᵣ−0.5)/(I_{g}=0.5)] (24)

Unlike the phase obtained in Eq. (20) with 2π discontinuities, the phase obtained here is already unwrapped naturally without the common limitations of conventional phase unwrapping algorithms. Therefore, it can be used to encode an arbitrary 3D scene scanned by a 3D scanner even with step height variations. It is important to notice that under the virtual fringe projection system all lighting can be controlled or eliminated, thus the phase can be obtained by two-channel fringe patterns with π/2 phase shift. This allows for the third channel to be used for phase unwrapping.

Since the phase is calculated point by point, it allows for leveraging the parallelism of the GPU for the decoding process. It is also important to notice that instead of directly using the stair image as previously shown, we use a cosine function to represent this stair image as described by Eq. (23). If the image is stored in a lossy format, the smooth cosine function causes less problems than the straight stair function with sharp edges.

From the unwrapped phase Φ(x,y) obtained in Eq. (24), the normalized coordinates (xⁿ, yⁿ, zⁿ) can be decoded as

$$\begin{matrix}{x}^{n} = j / W , & ( 25 ) \\ {y}^{n} = i / W , & ( 26 ) \\ {z}^{n} = \frac{P Φ ( x , y ) - 2 π i cos ( θ )}{2 π W sin θ} & ( 27 )\end{matrix}$$

This yields a value zⁿ in terms of P which is the fringe pitch, i, the index of the pixel being decoded in the Holovideo frame, θ, the angle between the capture plane and the projection plane (θ=18° for our case), and W, the number of pixels horizontally.

From the normalized coordinates (xⁿ,yⁿ,zⁿ), the original 3D coordinates can recovered point by point

x=xⁿ×S_{C}+Cₓ, (28)

y=yⁿ×S_{C}+C_{y}, (29)

z=zⁿ×S_{C}+C_{z}, (30)

Here S_{C} is the scaling factor to normalize the 3D geometry, (Cᵣ, C_{y}, C_{z}) are the center coordinates of the original 3D geometry.

Because of the subpixel sampling error, we found that some areas of the phase Φ(x,y) have one-pixel jumps along the edge of the stair image on I_{b}. This problem can be easily filtered out since it is only one pixel wide. The filter that we perform on the phase map is a median filter which removes spiking noise in the phase map. We used McGuire's method, allowing for a fast and efficient median filter in a GLSL Shader [14].

Normal calculation is done by calculating surface normals with adjacent polygons, and then averaging them together to form a normal map. Again, this uses the same setup as above with the orthogonal projection, render texture, and screen-aligned quad.

At last we have the final render step. Before we perform this step, we switch to a perspective projection, although an orthogonal projection could be used. We also bind the back screen buffer as the main render buffer, bind the final render shader, and then render a plane of pixels. With the plane of pixels, we can reduce the number of vertices by some divisor of the width and height of the Holovideo. This allows us to easily subsample the Holovideo, reducing the detail of the final rendering but also reducing the computational load. This is what allows the Holovideo to scale from devices with small graphics cards to those with large workstation cards.

4.1.5. 3D Video Compression

Because each frame is encoded with cosine functions, lossy image formats can be used. Therefore, lossy compression results in little loss of quality if the codec is properly selected. Most codecs use some transform that approximates the Karhunen-Lo'eve Transform (KLT) such as the cosine or integer transform. These transforms work the best on so-called natural images where there are no sharp discontinuities in the color space of the local block that the transform is applied to. Since the Holovideo uses cosine waves, the discontinuities are minimized and the transform yields highly compressed blocks which can then be quantized and encoded.

### 4.2. Experimental Results

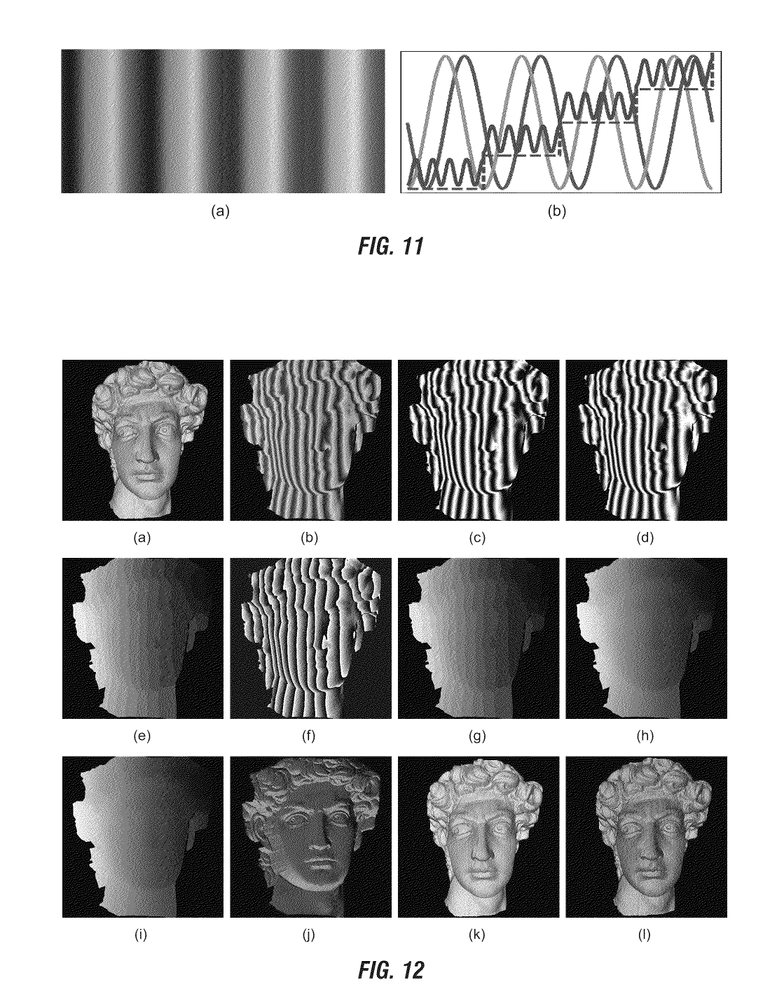

To verify the performance of the proposed Holovideo encoding system, we first encode one single 3D frame with rich features. FIG. 12 panels (a)-(l) show the results. For this example, the Holovideo system is configured as follows: The image resolution is 512(W)×512(H); The angle between the projection and the camera θ=18°; The fringe pitch P=32 pixels; The high-frequency modulation pitch P=6 pixels; And the stair height is S=16. FIG. 12(a) shows the original 3D geometry that is compressed into a single color Holoimage as shown in FIG. 12(b). The red and green channels are encoded as sine and cosine fringe patterns as shown in FIG. 12(c) and FIG. 12(d), respectively. FIG. 12(e) shows the blue channel image that is compose of stair with high-frequency cosine functions following Eq. (23). From the red and green channels, the phase can be wrapped with a value ranging from −π to +π as shown in FIG. 12(f). From the third channel, a stair image shown in FIG. 12(g) can be obtained, which can be used to unwrap the phase. FIG. 12(h) shows the unwrapped raw phase map Φ(x, y)^{r}. Because of the sub-pixel sampling issue, the perfectly designed stair image and the wrapped phase may have misalignment on edges. This figure shows some artifacts (white does) on the raw unwrapped phase map.

Because the artifacts are single pixel in width, they could be removed by applying a median filter to obtain smoothed unwrapped phase Φ^{S}(x, y). However, applying a single median filter will make the phase on those artifact points incorrect. Fortunately, because the phase changes must be multiples n(x,y) of 2π for those artifact points, we only need to determine the integer number n(x,y) to correct those points. In this research, n(x,y) was determined as

$$n ( x , y ) = Round [ \frac{{Φ}^{S} ( x , y ) - {Φ}^{r} ( x , y )}{2 π} ] , \qquad ( 31 )$$

and the correctly unwrapped phase map can be obtained by

Φ(x,y)=−Φ(x,y)^{r}+n(x,y)×2π. (32)

FIG. 121 shows the unwrapped phase map after properly removing those artifacts using the aforementioned procedures. The normal map can be calculated once the (x,y,z) coordinates could be calculated using Eqs. (28)-(30). FIG. 12J shows the computed normal map. Finally, 3D geometry could be rendered on GPU as shown in FIG. 12(k). To compare the precision of the reconstructed 3D geometry and the original 3D geometry, they are rendered in the same scene as shown in FIG. 12(l), here gold color geometry represents the original 3D geometry and the gray color represents the recovered 3D geometry. It clearly shows that they are well aligned together, which conforms to our previous finding: the error is negligible for the Holoimage to represent a 3D geometry [15].

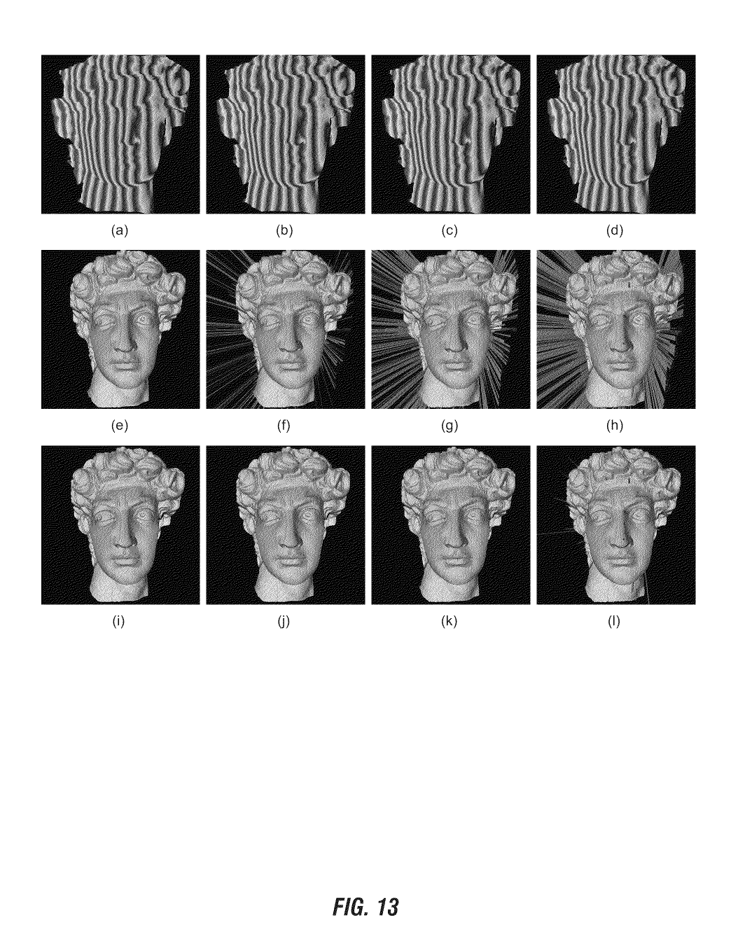

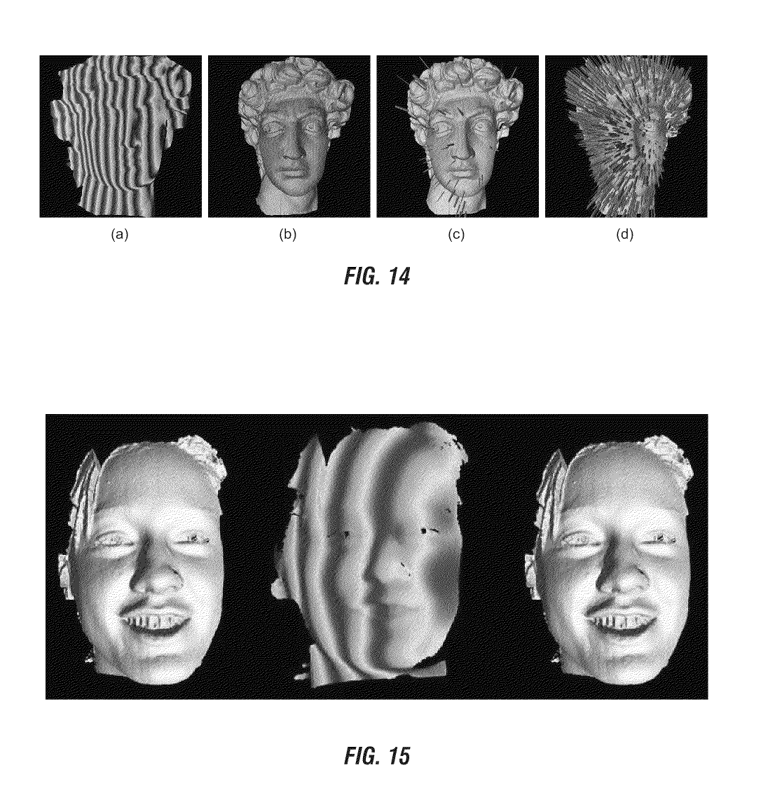

To demonstrate the potential of compressing Holovideo with lossy formats, we compressed a single frame with varying levels of JPEG compression under Photoshop 10.0. FIG. 14 shows the results of compressing the 3D frame shown FIG. 12. FIG. 13, panels (a)-(d) show compressed JPEG images with the quality levels of 12, 10, 8, 6, respectively. From these encoded images, the 3D shape can be recovered, as shown in FIG. 13 (e)-(h). It can been that the image can be stored as high quality lossy JPEG files without bringing obvious problems to recovered 3D geometry.

With more compressed images being used, the recovered 3D geometry quality reduces (i.e., losing details), and some artifacts (spikes) start appearing. However, most of problematic points occur around boundary regions which are caused by sharp intensity changes of the image. The boundary problems can be significantly reduced if a few pixels are dropped out. FIG. 13(i)-(l) shows the corresponding results after removing the boundary. This experiment clearly indicates that the proposed encoding method allows the use of the lossy imaging format.

OBJ file format is widely used to store 3D mesh data. If the original 3D data is stored in OBJ format without normal information, the file size is 20,935 KB. In comparison with the OBJ file format, we could reach 174:1 with slight quality dropping. When the compression ratio reaches 310:1, the quality of 3D geometry is noticeability reduced, but the overall 3D geometry is still well preserved.

As a comparison, if we use the encoding method previously discussed with blue channels as a straight stair function. The encoded image is shown in FIG. 14(a). If the image is stored as lossless format (e.g., bitmap), the 3D geometry can be accurately recovered as illustrated in FIG. 14(b). FIG. 14(c) shows that even the image is stored as the highest quality level (12) JPEG format, the 3D recovered result appears to be problematic. If the image quality is reduced to quality level 10, the 3D shape cannot be recovered, as show in FIG. 14(d). It is important to note that the boundaries of 3D recovered results were cleaned using the same aforementioned approach. This clearly demonstrates that the previously proposed encoding method cannot be used if a lossy image format is needed.

To show that the proposed method can be used to encode and decode 3D videos, we capture a short 45-second clip of an actress using a structured light scanner [16] running at 30 FPS with an image resolution of 640£480 per frame. Saving each frame out in the OBJ format, we end up with over 42 GB worth of data. Then we took the data, ran it through the Holovideo encoder, and saved the raw lossless 24-bit Bitmap data to an AVI file with a resolution of 512×512, which resulted in a file that was 1 GB. This is already a compression of over 42:1 Holovideo to OBJ. Next we JPEG-encoded each frame and ran it through the QTRLE codec, which resulted in a file that was 314.3 MB, achieving a ratio of over 134:1 Holovideo to OBJ. Media 1 associated with FIG. 15 shows the original scanned 3D video (the video on the left), the encoded Holovideo (the video in the middle), and the decoded 3D video (the video on the right). The resulting video had no noticeable artifacts from the compression, and it could be further compressed with some loss of quality. All of the encoding and decoding processes are performed on the GPU in real-time (28 FPS decoding and 18 FPS encoding) with a simple graphics card (NVIDIA GeForce 9400m) and the resulting compression ratio is over 134:1 in comparison with the 3D data stored in OBJ file format.

### 4.3. Discussion

One caveat to note is that a lot of video codecs are tailored to the human eye and reduce information in color spaces that humans typically do not notice. An example of this is the H.264 codec which converts source input into the YUV color space. The human eye has a higher spatial sensitivity to luma (brightness) than chrominance (color). Knowing this, bandwidth can be saved by reducing the sampling accuracy of the chrominance channels with little impact on human perception of the resulting video.

Compression codecs that use the YUV color space currently do not work with the Holovideo compression technique as they result in large blocking artifacts. Thus we used the QTRLE codec which is a lossless run length encoding video codec. To achieve lossy video compression, we JPEG-encoded the source images in the RGB color space and then passed them to the video encoder. This allows us to achieve a high compression ratio at a controllable quality level. The present invention contemplates the use of other fringe patterns which fit into the YUV color space.

### 5. Applications

The present invention contemplates numerous applications. As 3-D computing and 3-D television become practicable, the need for compression of unstructured 3-D geometry will become apparent. Currently 2-D video conferencing is becoming more widespread with programs such as Skype seeing widespread exposure augmented with the relatively cheap hardware requirements of webcams. Skype is one example of video conferencing software that can run on typical consumer computing platforms and is also available for other types of computing devices, including certain mobile phones. As 3-D replaces 2-D, 3-D video conferencing or 3-D video calls may replace 2-D video conferencing and 2-D calls. Holoimage technology creates a platform for this technology as it compresses 3-D into 2-D, which then allows the existing platform of 2-D to be leveraged. Once compressed into 2-D, video codecs may be used to compress the Hologimage, along with existing network protocols and infrastructure. Instead of passing a single video, two videos are passed requiring more bandwidth, but the bandwidth requirement is substantially lower than what would be required if the geometry were to be transferred in traditional methods. Client programs such as Skype would require slight adjustment to accept the new 3-D video stream, but would afford for 3-D video conferencing with a small hardware requirement. Thus, the present invention contemplates that the methods described herein may be used in any number of applications and for any number of purposes, including video conferencing or video calling.

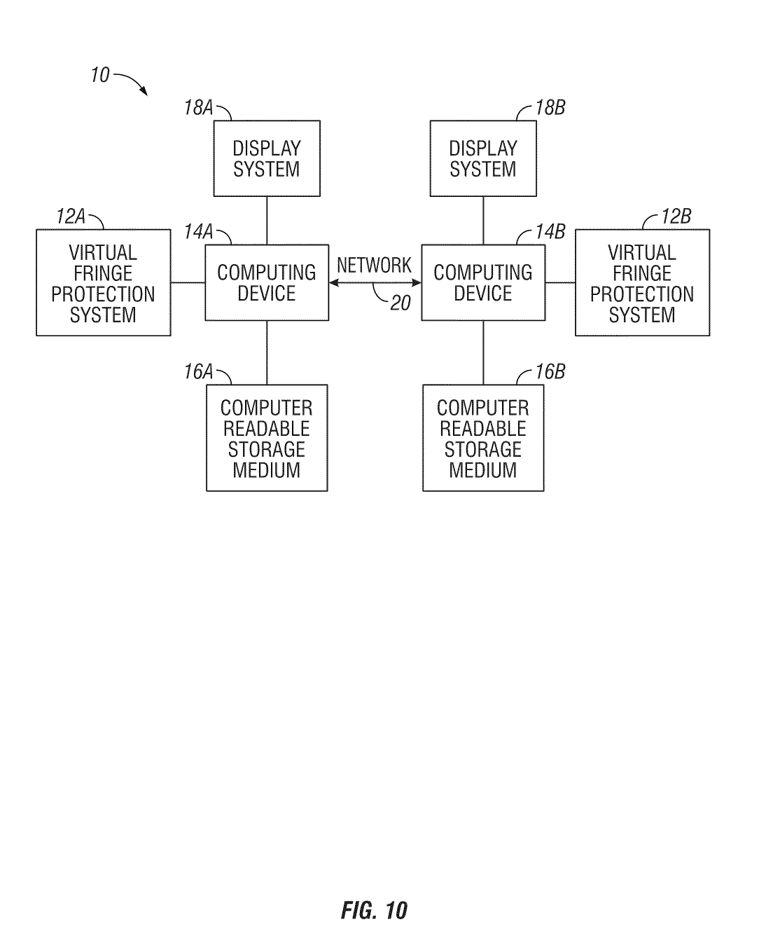

FIG. 10 illustrates one embodiment of a system in which two devices are capable of acquiring and displaying 3-D imagery and communicating the 3-D imagery bi-directionally over a network. In the system 10 of FIG. 10, a first virtual fringe projection system 12A is shown. This may correspond with the example of such a system shown in FIG. 1. A computing device 14A is operatively connected to the virtual fringe projection system 12A. The computing device 14A is operatively connected to a display system 18A and a computer readable storage medium 16A. The computing device 14A is operatively connected to at least one additional computing device such as computing device 12B over a network 20. The computing device 12B may also be operatively connected to a display system 18B, a virtual fringe projection system 14B, and a computer readable storage medium 16B.

The system 10 allows for real-time acquisition and storage or communication of the 3-D imagery. The system 10 may be used in 3-D video conferencing or other applications. The network 20 may be any type of network including the types of networks normally associated with telecommunications.

### 6. Conclusion

Here, we successfully demonstrate that an arbitrary 3-D shape can be represented as a single color image, with red and green channel being represented as sine and cosine fringe images, and the blue channel encoded as a phase unwrapping stair function. Storing 3-D geometry in a 2-D color image format allows for conventional image compression methods to be employed to compress the 3-D geometry. However, we found that lossy compression algorithms cannot be incorporated because of the third channel containing sharp edges. Lossless image formats, such as PNG or bitmap must be used to store the blue channel because it contains sharp edges, while red and green channels can be stored in any image format. Comparing with the native smallest possible 3-D data representation method, we have demonstrated that with a compression ratio of 1:36.86, the shape quality did not reduce at all. The compression ratio is much larger if other 3-D formats are used.

By compressing 3-D geometry into 24-bit color images, the compression ratio is very high. However, after conversion, the original 3-D data connectivity information is lost and the data is re-sampled. It should be noted that because the shape reconstruction can be conducted pixel by pixel, it is very suitable for parallel processing, thus allowing for real-time shape transmission and visualization.

We also show that by replacing the blue channel with a different structure, the phase can still be unwrapped and sharp edges may be reduced or eliminated such that a lossy compression algorithm can be incorporated.

We have also presented a technique which can encode and decode high-resolution 3D data in realtime, thus achieving 3D video. Decoding was performed at 28 FPS and encoding was performed at 17 FPS on an NVIDIA GeForce 9400m GPU. Due to the design of the algorithm, standard 2D video codecs can be applied so long as they can encode in the RGB color space. Our results showed that a compression ratio of over 134:1 can be achieved in comparison with the OBJ file format. By using 2D video codecs to compress the geometry, existing research and infrastructure in 2D video can be leveraged in 3D.

The present invention contemplates numerous options, variations, and alternatives. For example, the present invention contemplates that a first image compression method may be used to store the red and green channels while a second image compression method may be used to store the blue channel, with the first image compression method being lossy and the second image compression method being lossless. The present invention contemplates that an algorithm may be used for the blue channel to allow a lossy image compression method to be used for the blue channel as well. The present invention contemplates that the resulting image may be stored in any number of formats. The present invention contemplates that the methodology may be used in any number of applications where it is desirable to use 3-D data.

Although various embodiments have been described, it is to be understood that the present invention is not to be limited to these specific embodiments.

### REFERENCES

[1] S. Rusinkiewicz, O. Hall-Holt, and M. Levoy, “Real-time 3-D model acquisition,” ACM Trans. Graph. 21(3), 438-446 (2002).
[2] C. Guan, L. G. Hassebrook, and D. L. Lau, “Composite structured light pattern for three-dimensional video,” Opt. Express 11(5), 406-417 (2003).
[3] L. Zhang, B. Curless, and S. Seitz, “Spacetime stereo: Shape recovery for dynamic scenes,” in Proc. Computer Vision and Pattern Recognition, 367-374 (2003).
[4] J. Davis, R. Ramamoorthi, and S. Rusinkiewicz, “Spacetime stereo: A unifying framework for depth from triangulation,” IEEE Trans. Patt. Anal. and Mach.e Intell. 27(2), 1-7 (2005).
[5] S. Zhang and P. S. Huang, “High-resolution, real-time three-dimensional shape measurement,” Opt. Eng. 45, 123601 (2006).
[6] S. Zhang and S.-T. Yau, “High-speed three-dimensional shape measurement using a modified two-plus-one phase-shifting algorithm,” Opt. Eng. 46(11), 113603 (2007).
[7] X. Gu, S. Zhang, P. Huang, L. Zhang, S.-T. Yau, and R. Martin, “Holoimages,” in Proc. ACM Solid and Physical Modeling, 129-138 (2006).
[8] D. P. Towers, J. D. C. Jones, and C. E. Towers, “Optimum frequency selection in multi-frequency interferometry,” Opt. Lett. 28, 1-3 (2003).
[9] C. E. Towers, D. P. Towers, and J. D. C. Jones, “Absolute fringe order calculation using optimised multi-frequency selection in full-field profilometry,” Opt. Laser Eng. 43, 788-800 (2005).
[10] Y.-Y. Cheng and J. C. Wyant, “Multiple-wavelength phase shifting interferometry,” Appl. Opt. 24, 804-807 (1985).
[11] P. K. Upputuri, N. K. Mohan, and M. P. Kothiyal, “Measurement of discontinuous surfaces using multiple-wavelength interferometry,” Opt. Eng. 48, 073603 (2009).
[12] D. C. Ghiglia and M. D. Pritt, Two-Dimensional Phase Unwrapping: Theory, Algorithms, and Software, John Wiley and Sons, Inc (1998).
[13] H. Schreiber and J. H. Bruning, Optical shop testing, chap. 14, pp. 547-666, 3rd ed. (John Willey & Sons, New York, N.Y., 2007).
[14] M. McGuire, “A fast, small-radius GPU median filter,” in ShaderX6 (2008).
[15] S. Zhang and S.-T. Yau, “Three-dimensional data merging using Holoimage,” Opt. Eng. 47(3), 033,608 (2008) (Cover feature).
[16] S. Zhang and S.-T. Yau, “High-resolution, real-time 3-D absolute coordinate measurement based on a phaseshifting method,” Opt. Express 14(7), 2644-2649 (2006).
[17] D. C. Ghiglia and M. D. Pritt, Two-dimensional phase unwrapping: Theory, algorithms, and software (John Wiley and Sons, Inc, New York, N.Y., 1998).

What is claimed is:

1. A method comprising:
(a) acquiring a 3-D geometry through use of a virtual fringe projection system;
(b) storing a representation of the 3-D geometry as a RGB color image on a computer readable storage medium.

2. The method of claim 1 wherein a sine fringe image is represented on a first RGB channel of the RGB color image and a cosine fringe image is represented on a second RGB channel of the RGB color image, and phase unwrapping information is represented on a third RGB channel of the RGB color image.

3. The method of claim 1 wherein the storing the representation comprises storing as a file having a compressed format.

4. The method of claim 1 further comprising repeating steps (a) and (b) and associating each representation of the 3-D geometry together to provide video.

5. The method of claim 1 wherein steps (a) and (b) are performed in real-time.

6. A method for storing a representation of a 3-D image, comprising:
storing on a computer readable storage medium a 24-bit color image having a red channel, a green channel, and a blue channel;
wherein a first of the channels comprises a representation of a sine fringe image; and
wherein a second of the channels comprises a representation of a cosine fringe image.

7. The method of claim 6 wherein a third of the channels comprises a representation of a stair image for use in phase unwrapping.

8. The method of claim 6 wherein a third of the channels comprises a representation of a sinusoidal fringe image.

9. The method of claim 6 wherein the 24-bit color image is stored in a lossy format.

10. The method of claim 9 wherein the lossy format is a loseless image format.

11. The method of claim 6 wherein the 24-bit color image is stored in a compressed format.

12. The method of claim 6 further comprising transferring the 24-bit color image.

13. A computer readable storage medium having stored thereon one or more sequences of instructions to cause a computing device to perform steps for generating a 24-bit color image, the steps comprising: storing a representation of a 3-D geometry acquired through use of a virtual fringe projection system as a 24-bit color image.

14. The computer readable storage medium of claim 13 wherein a sine fringe image is represented on a first channel of the 24-bit color image and a cosine fringe image is represented on a second channel of the 24-bit color image, and phase unwrapping information is represented on a third channel of the 24-bit color image.

15. The computer readable storage medium of claim 13 wherein the one or more sequences of instruction cause the computing device to generate the 24-bit color image in a compressed format.

16. The computer readable storage medium of claim 13 wherein the 24-bit color image is stored in a lossy format.

17. The computer readable storage medium of claim 13 wherein the 24-bit color image is stored in a loseless format.

18. The computer readable storage medium of claim 13 wherein the 24-bit color image has a red channel, a green channel, and a blue channel.

19. A method comprising:
receiving a representation of a 3-D geometry as a color image having a sine image on a first channel, a cosine image on a second channel and phase unwrapping information on a third channel;
processing the color image on a computing device to use the sine image, the cosine image, and the phase unwrapping information to construct a representation of the 3-D geometry.

20. The method of claim 18 wherein the receiving comprises receiving a file containing the color imagery.

21. The method of claim 18 wherein the receiving comprises receiving a video stream containing the color image.

22. The method of claim 18 wherein the video stream is associated with video conferencing or video calling.
